(19) United States
(12) Patent Application Publication
(10) Pub. No.: US 2014/0059106 A1
(43) Pub. Date: Feb. 27, 2014

(54) ARITHMETIC CIRCUIT FOR PERFORMING DIVISION BASED ON RESTORING DIVISION

(71) Applicant: Fujitsu Limited, Kawasaki-shi (JP)

(72) Inventors: Kensuke Shinomiya, Inagi (JP); Kenichi Kitamura, Kawasaki (JP)

(21) Appl. No.: 13/935,175

(22) Filed: Jul. 3, 2013

(30) Foreign Application Priority Data
Aug. 21, 2012 (JP) 2012-182344

(51) Int. Cl. G06F 7/52

(52) U.S. Cl. CPC G06F 7/52
USPC 708/650

(57) ABSTRACT

An arithmetic circuit for performing division based on restoring division includes an intermediate remainder register configured to store an intermediate remainder, a quotient prediction circuit configured to perform, based on information about two most significant digits of the intermediate remainder and a most significant digit of a divisor, quotient prediction having lower precision than a highest precision obtainable from the information, thereby generating a prediction result, a fixed-value multiplication circuit configured to output one or more N-th (N: integer) multiples of the divisor selected in response to the prediction result, one or more subtracters configured to subtract, from the intermediate remainder, the one or more N-th multiples of the divisor output from the fixed-value multiplication circuit, and a partial quotient calculating circuit configured to obtain a partial quotient in response to one or more carry-out bits of one or more subtractions performed by the one or more subtracters.

### CROSS-REFERENCE TO RELATED APPLICATIONS

The present application is based upon and claims the benefit of priority from the prior Japanese Patent Application No. 2012-182344 filed on Aug. 21, 2012, with the Japanese Patent Office, the entire contents of which are incorporated herein by reference.

### FIELD

The disclosures herein relate to an arithmetic circuit, a processor, and a division method.

### BACKGROUND

Among the four arithmetic operations with respect to binary coded decimals, the division operation is a low-speed operation that involves a greater number of operation cycles than do the other arithmetic operations. In general, a high-precision division operation obtains a partial quotient and an intermediate remainder by use of restoring division. Generation of such an intermediate reminder becomes a critical factor. In basic restoring division, subtracting a divisor from an intermediate remainder is repeated. The fact that the arithmetic result has become negative leads to a conclusion that too many subtractions have been performed, so that the result obtained prior to the subtraction in the instant cycle is used as a partial quotient.

In the following, a procedure of restoring division will be described. In the following description, a dividend and an intermediate remainder will not be discriminated from each other, and will collectively be referred to as an intermediate remainder. At the beginning, an intermediate remainder, a divisor, and a partial quotient are supplied from an intermediate quotient register, a divisor register, and a partial quotient register, respectively. In the first subtraction loop, the partial quotient is zero. The following processes will be performed in the first and subsequent subtraction loops. First, the partial quotient is counted up. Next, a subtraction circuit subtracts the divisor from the intermediate remainder to produce a subtraction result and a carry-out bit. In the case of the carry-out bit being 1 (indicating that the result is a positive number), the subtraction result is stored in the intermediate remainder register, and the partial quotient counted up at the beginning of the current subtraction loop is stored in the partial quotient register, followed by proceeding to the next subtraction loop. In the case of the carry-out bit being 0 (indicating that the result is a negative number), the value stored in the intermediate remainder register (i.e., the value in existence prior to the subtraction in the current subtraction loop) is stored in the intermediate remainder register, and the value stored in the partial quotient register (i.e., the value in existence prior to counting up in the current subtraction loop) is stored in the partial quotient register. The procedure then comes to a halt. The value of the intermediate remainder register and the value of the partial quotient register at this moment are the final result values of the intermediate remainder and the partial quotient, respectively.

In this manner, restoring division involves repeating the process of subtracting a divisor from an intermediate remainder until the intermediate remainder becomes negative in order to produce a partial quotient and an intermediate remainder. In the case of decimal numbers, a one-digit quotient can assume any value in a range of 0 to 9, so that subtraction operations may be repeated up to ten times. Such a procedure is repeated until all the quotients for all the digits are obtained. The latency of an arithmetic device for performing division may become exacerbated.

The problem of basic restoring division is that the number of repeated subtraction loops for generating an intermediate remainder and a partial quotient is large. A common approach to obviating this problem may calculate one or more N-th multiples (N: integer) of the divisor in advance, and may then subtract these N-th multiples of the divisor from the intermediate remainder, respectively, followed by categorizing the results.

For example, a known method calculates first, second, and fifth multiples of a divisor in advance (see Patent Document 1, for example). In the first subtraction operation, the fifth multiple of the divisor is subtracted from the intermediate remainder. When the result is a negative number, this fact indicates that subtracting the fifth multiple of the divisor is excessive. It is thus concluded that the one-digit quotient is in the range of 0 to 4. Otherwise, it is concluded that the one-digit quotient is in the range of 5 to 9. In this manner, restoring division may be performed in a coarse fashion by using one or more N-th multiples of a divisor to narrow the range of values that the quotient can assume in the next cycle, thereby reducing the number of loops performed for generating a partial quotient and an intermediate remainder. According to the disclosed algorithm, the final result can be obtained by performing loops up to four times (Patent Document 1).

In stead of using one subtracter (see Patent Document 1), a plurality of subtracters may be used to obtain the results of subtractions with regard to two or more N-th multiples of a divisor at the same time. This serves to further enhance the speed. In an extreme example, the first through ninth multiples of a divisor may be prepared in advance, and nine subtracters may be utilized to produce all the results only in one loop. Alternatively, the first, second, third and sixth multiples of a divisor may be prepared in advance, and two subtracter circuits may be used to produce the results (see Patent Document 2, for example).

Another known method predicts a partial quotient and an intermediate remainder from the states of a dividend and a divisor in addition to the above-noted speed enhancement achieved by subtracting one or more N-th multiples of a divisor. For example, circuits may be configured to check, at the time of performing the second subtraction, the intermediate remainder and the states of upper order digits of the third multiple of a divisor, thereby selecting an N-th multiple of a divisor used in the second subtraction (Patent Document 2, for example). Speed enhancement may also be achieved by adding a quotient predicting circuit capable of predicting a partial quotient with an error margin of 1 or less based on the states of the intermediate remainder and the divisor and also by adding a circuit for correcting such an error (Patent Document 3, for example).

In the speed enhancement achieved by use of two or more N-th multiples of a divisor, there is a tradeoff between an increase in circuit size and the number of loops. When a division operation that uses a small number of subtracters is desirable due to hardware constrains, the number of cycles performed to obtain results becomes large. Further, an increase resulting from the addition of circuits is a bottleneck in the speed enhancement achieved by quotient prediction. When a control circuit is embedded in the loop that produces a partial quotient and an intermediate remainder, the number of logic stages in the loop is increased. High operating frequency implementation in such a case is difficult although the latency is improved by the reduction in the number of loops.

Even when quotient prediction and quotient correction are performed at high speed, the presence of a large number of remainder types and/or the use of an arithmetic circuit for multiplying a fixed number of 3N give rise to a problem (Patent Documents 2 and 3, for example). In a decimal-number arithmetic unit, the arithmetic circuit for multiplying a fixed number of 3N cannot be implemented without using an adder. The following three methods are conceivable to achieve this goal.

(1) An adder is added immediately before an adder
(2) Shared use with a subtracter is made.
(3) The sixth multiple of a divisor is generated prior to a loop, and is kept in a register.

The use of the method (1) causes the number of logic stages to be increased by a number equal to the number of adders, thereby imposing a negative effect on the delay. The use of the method (2) involves adding one cycle for generating a partial quotient and an intermediate remainder, and also complicates a control procedure. The use of the method (3) involves adding a register having a width equal to the width of a divisor, which gives rise to a problem of circuit area size.

Further, since quotient prediction involves a heavy logic operation, performing quotient prediction and subtraction simultaneously within one cycle is difficult in the case of high operating frequency. In such a case, the operation cycle may be divided, thereby posing a risk of deteriorating latency.

In the case of Patent Document 2, an intermediate remainder and the two upper digits of the third multiple of a divisor are compared as a method of quotient prediction. Since a comparator is generally implemented by use of an adder, this arrangement involves the use of an additional two-digit adder. In the case of high operating frequency, there is also a risk of deteriorating latency.
[Patent Document 1] Japanese Laid-open Patent Publication No. 57-125442
[Patent Document 2] Japanese Laid-open Patent Publication No. 07-239774
[Patent Document 3] Japanese Laid-open Patent Publication No. 07-160480

### SUMMARY

According to an aspect of the embodiment, an arithmetic circuit for performing division based on restoring division includes an intermediate remainder register configured to store an intermediate remainder, a quotient prediction circuit configured to perform, based on information about two most significant digits of the intermediate remainder and a most significant digit of a divisor, quotient prediction having lower precision than a highest precision obtainable from the information, thereby generating a prediction result, a fixed-value multiplication circuit configured to output one or more N-th (N: integer) multiples of the divisor selected in response to the prediction result generated by the quotient prediction circuit, one or more subtracters configured to subtract, from the intermediate remainder, the one or more N-th multiples of the divisor output from the fixed-value multiplication circuit, and a partial quotient calculating circuit configured to obtain a partial quotient in response to one or more carry-out bits of one or more subtractions performed by the one or more subtracters.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a table illustrating the number of remaining subtractions which is defined with respect to each of the different combinations of the number of adders and the possible number of quotients at the time of subtraction;

FIG. 2 is a drawing illustrating a table which provides combinations of the two most significant digits of an intermediate remainder and the most significant digit of a divisor;

FIG. 3 is a table illustrating examples of a partial quotient value obtained as a result with respect to a combination of a first subtraction outcome and a second subtraction outcome when an arithmetic unit can obtain the result with two adders by use of two loops;

FIG. 4 is a flowchart illustrating a process flow of the algorithm illustrated in FIG. 3;

FIG. 5 is a drawing illustrating an example of the configuration of a computer system;

FIG. 6 is a drawing illustrating an example of the configuration of an arithmetic circuit;

FIG. 7 is a truth table illustrating the input and output of each digit in a second-multiple circuit;

FIG. 8 is a truth table illustrating the input and output of each digit in a fifth-multiple circuit;

FIG. 9 is a drawing illustrating an example of the configuration of a quotient prediction circuit;

FIG. 10 is a drawing illustrating an example of the configuration of a fixed-value multiplication circuit;

FIG. 11 is a drawing illustrating an example of the configuration of a multiple selecting circuit;

FIG. 12 is a table illustrating relationships between inputs and outputs of the multiple selecting circuit and the fixed-value multiplication circuit;

FIG. 13 is a drawing illustrating an example of the configuration of an intermediate remainder selecting circuit;

FIG. 14 is a drawing illustrating relationships between inputs and outputs of the intermediate remainder selecting circuit;

FIG. 15 is a drawing illustrating an example of the configuration of a control circuit;

FIG. 16 is a drawing illustrating an example of the configuration of a partial quotient calculating circuit;

FIG. 17 is a drawing illustrating relationships between inputs and outputs of the partial quotient calculating circuit; and

FIG. 18 is a drawing illustrating relationships between inputs and outputs of a constant-value table.

### DESCRIPTION OF EMBODIMENTS

In the following, embodiments of the invention will be described with reference to the accompanying drawings.

When division is performed by use of one or more N-th multiples of a divisor, the number of subtraction loops involved varies depending on the number of adders. When the optimal N-th multiples of a divisor are used, the number of subtraction loops involved is represented by the following formula. logₐ₊₁A=B (digits below a decimal points are rounded up in B)

Here, “a” represents the number of adders, “A” representing the possible range of partial quotients, and “B” representing the maximum number of subtractions performed to obtain the partial quotient.

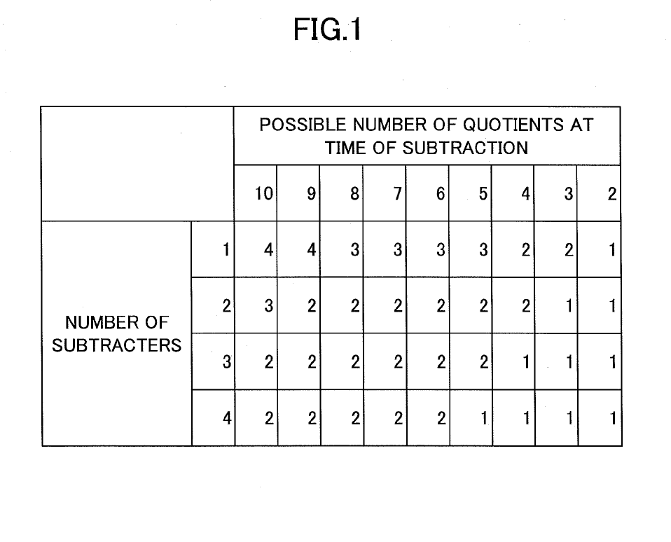

FIG. 1 is a table illustrating the number of remaining subtractions which is defined with respect to each of the different combinations of the number of adders and the possible number of quotients at the time of subtraction. In the case of decimal division, for example, a quotient can take any value in the range of 0 to 9. Namely, a quotient can take any one of the 10 different values, so that the possible number of quotients at the time of subtraction is equal to 10. In FIG. 1, in the column for which the possible number of quotients at the time of subtraction is 10, the number of remaining subtractions is 4 when the number of subtracters is 1. Namely, the use of the optimal N-th multiple of a divisor (e.g., the use of the fifth multiple of a divisor at the beginning) ensures that the results are obtained by performing loops a maximum of four times because the number of remaining subtractions is 4. In the case in which the possible number of quotients at the time of subtraction is 10, the number of remaining subtractions, i.e., the number of loops, is 3 when the number of subtracters is 2.

Assuming that the number of adders is 1, the number of quotient candidates in the initial state may be reduced to 8 by performing some preprocessing such as quotient prediction. In such a case, the number of loops can be reduced to 3 from 4, which is the number of loops performed when the number of quotient candidates is 10. Assuming that the number of adders is 2, the number of quotient candidates in the initial state may be reduced to 9 by performing some preprocessing such as quotient prediction. In such a case, as is understood from the table of FIG. 1, the number of loops can be reduced to 2 from 3, which is the number of loops performed when the number of quotient candidates is 10.

In order to reduce the possible number of quotients from 10 to m (m: an integer smaller than 10), the 10 quotient candidates may be divided into a plurality of groups each including no more than m quotients, and, then, one group may be identified by use of quotient prediction. Each group is a sub-set of the set that contains all the possible values (i.e., 10 values) of quotients. In order to reduce the possible number of quotients from 10 to 9, for example, the 10 quotient candidates may be divided into two groups each including no more than 9 quotients, and, then, one group may be identified by use of quotient prediction. In so doing, the two groups may have an overlap with each other. Namely, the two groups may include one or more identical quotients.

What this means is that sufficient processing speed enhancement may be achieved by performing coarse quotient prediction without the need for performing high precision quotient prediction as disclosed in Patent Document 3. Coarse quotient prediction may be performed by using information about the two most significant digits of an intermediate remainder and the most significant digit of a devisor.

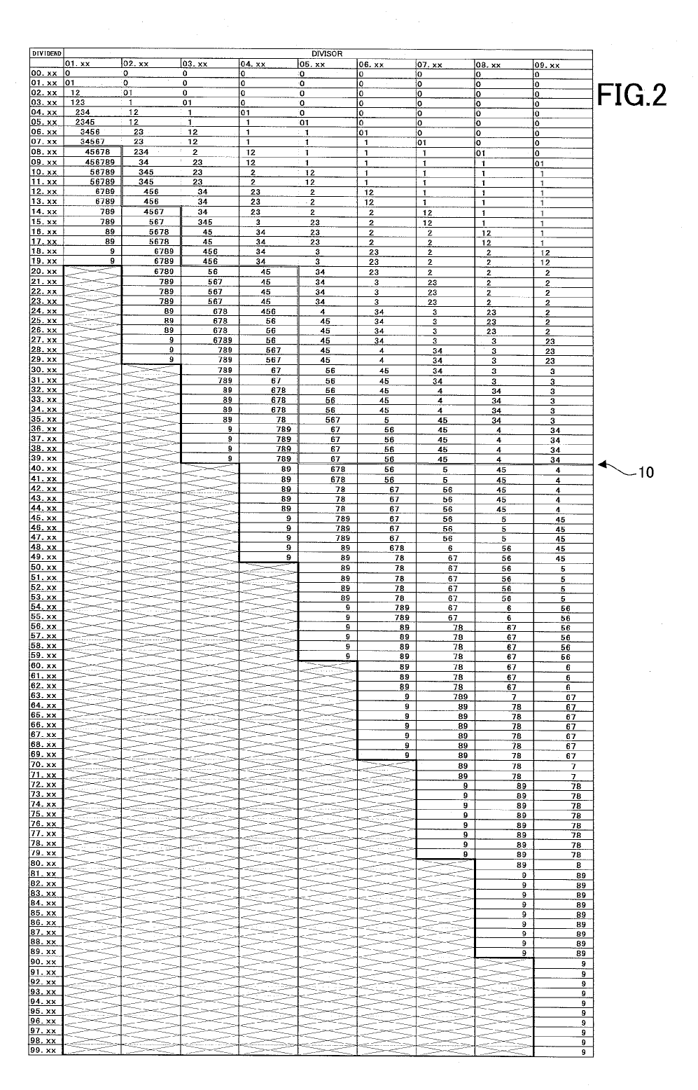

FIG. 2 is a drawing illustrating a table which provides combinations of the two most significant digits of an intermediate remainder and the most significant digit of a divisor. The leftmost column lists the two most significant digits of a dividend (i.e., intermediate remainder), and the topmost row lists the most significant digit of a divisor. An entry at an intersection between a row and a column shows the possible range of quotients with respect to the corresponding combination of a dividend and a divisor. In this example, the dividend and the divisor are both decimal numbers. When the dividend is 08.xx (xx: any numerals) and the divisor is 01.xx, for example, the possible range of partial quotients is identified as 4 to 8 (i.e., 4, 5, 6, 7, 8) in the table of FIG. 2. This indicates that when both a condition of “8.00≦dividend<9.00” and a condition of “1.00≧divisor<2.00” are satisfied, a condition of “4≧partial quotient≦8” is satisfied. In the table of FIG. 2, the hatched portion represents impossible combinations in the case of restoring division. This table contains a vast amount of data corresponding to 100 rows by 9 columns. However, there is no need to incorporate all the data in this table in quotient prediction. When information at hand indicates that the dividend is 0.8.xx and the divisor is 01.xx, the possible range of quotients that can be ascertained from this information is 4 to 8. In this case, the number of quotients included in this range is 5. As previously described, assuming that the number of adders is 1, the number of quotient candidates in the initial state may be reduced to 8 by performing some preprocessing such as quotient prediction. In such a case, the number of loops can be reduced to 3 from 4, which is the number of loops performed when the number of quotient candidates is 10. Assuming that the number of adders is 2, the number of quotient candidates in the initial state may be reduced to 9 by performing some preprocessing such as quotient prediction. In such a case, as is understood from the table of FIG. 1, the number of loops can be reduced to 2 from 3, which is the number of loops performed when the number of quotient candidates is 10.

In the case of the number of adders being 2, for example, it suffices to reduce the possible number of quotients obtained by quotient prediction to 9 or less. There is thus no need to use all the data contained in the table of FIG. 2 for the purpose of quotient prediction. Since reducing the number of quotients in each group to 9 or less is sufficient, there is no need to go as far as to identify a group of quotients obtained from the above-noted information indicative of the fact that the dividend is 08.xx and the divisor is 01.xx. Namely, it suffices to reduce the possible number of quotients to 9 or less by performing, based on the information about the two most significant digits of the dividend and the most significant digit of the divisor, quotient prediction having lower precision than the highest precision (e.g., precision identifying 4 to 8) that is obtainable from such information.

In order to perform lower-precision quotient prediction, i.e., coarse quotient prediction, the table of FIG. 2 may be divided at an appropriate boundary in response to the number of adders used and the desirable number of subtraction loops. For example, an arithmetic unit may be designed such that the results are obtained with two adders by performing two loops. In such a case, the table of FIG. 2 may be divided by a boundary so that the possible range of quotients is divided into a group of 0 to 7 and a group of 4 to 9. Each group is a sub-set of the set that contains all the possible values (i.e., 0 to 9) of partial quotients. Further, these two groups overlap with each other, and share the same elements 4, 5, 6, and 7.

In this manner, division is made to obtain two groups each including 9 or less quotients. When quotient prediction as will be described later is performed to identify one of the groups, the number of quotient candidates in the initial state is reduced to at most 9. With this arrangement, in the case of two adders being used, as is understood from the table of FIG. 1, the number of loops can be reduced to 2 from 3, which is the number of loops in the case of the number of quotient candidates being 10.

In the table of FIG. 2, the reason why this particular boundary 10 is used to create the two groups is because the use of such a boundary allows quotient prediction to be made by use of simple logic. When attention is focused on the column corresponding to the divisor being 01.xx, division into the intermediate remainder being 8 (1000₂) or greater and the intermediate remainder being smaller than 8 (1000₂) creates a group of quotients being in a range of 0 to 7 and a group of quotients being in a range of 4 to 9. In this case, quotient prediction can be made simply by checking the most significant bit of the intermediate remainder. Namely, checking the most significant bit of the intermediate remainder suffices to identify one of the two groups as the group in which the quotient belongs. Alternatively, division could be made such as to create a group of quotients being 0 to 8 and a group of quotients being 4 to 9. In such a case, a boundary would be set such that the intermediate remainder is 9 (1001₂) or greater for one group, and is smaller than 9 (1001₂) for the other group. Such division involves checking all the four bits of the intermediate remainder. The boundary 10 is chosen such that desired grouping is obtained only by checking as fewer partial bits as possible without the need to check all the bits of the intermediate remainder.

In the example of grouping made by the boundary 10 described above, the number of elements in each group (i.e., the number of quotients included in each group) is 8 or less. With this arrangement, thus, also in the case of one adder being used, as is understood from the table of FIG. 1, the number of loops can be reduced to 3 from 4, which is the number of loops in the case of the number of quotient candidates being 10. Similarly, grouping based on 3-fold division may be made in the table of FIG. 2 such that the number of elements included in each group is 4 or less, thereby reducing the number of subtraction loops from 2 to 1 in the table of FIG. 1 in the case of three adders being used.

The coarse quotient prediction disclosed herein performs, based the information about the two most significant digits of a dividend (i.e., intermediate remainder) and the most significant digit of a divisor, quotient prediction having lower precision than the highest precision that is obtainable from such information. This coarse quotient prediction is not limited to the use of a particular number of adders or a particular number of loops. This coarse quotient prediction does not identify a quotient range specified at an intersection between the row and the column that are identified by use of the two most significant digits of a dividend and the most significant digit of a divisor, but rather identifies a group of a plurality of intersections between rows and columns. Further, this coarse quotient prediction may be performed by using only part of all the bits that are comprised of the two most significant digits of a dividend (i.e., intermediate remainder) and the most significant digit of a devisor, for example.

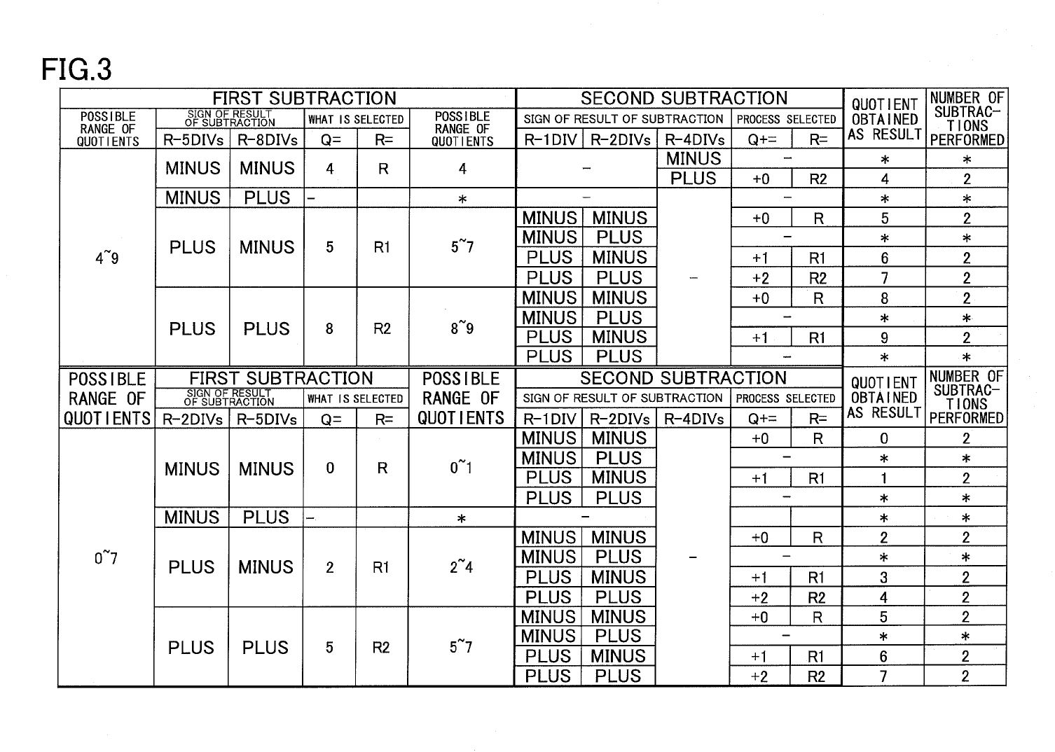

FIG. 3 is a table illustrating examples of a partial quotient value obtained as a result with respect to a combination of a first subtraction outcome and a second subtraction outcome when an arithmetic unit can obtain the result with two adders by use of two loops. In this example, quotient prediction is made such that the possible range of quotients is divided into a group of quotients being 0 to 7 and a group of quotients being 4 to 9 as previously described. The contents of this table are based on an algorithm that is only intended to be an example, and are not intended to limit which N-th multiples of a divisor are used, how a partial quotient and an intermediate remainder are obtained, etc.

In FIG. 3, an intermediate remainder is represented by R, and a divisor is represented by DIVs, with a partial quotient being represented by Q. Further, subtraction results (i.e., intermediate remainders) obtained by first and second adders (i.e., subtracters) are represented by R1 and R2, respectively, and carry-out bits of the subtractions performed by the first and second adders (i.e., subtracters) are represented by CO1 and CO2, respectively. As illustrated in FIG. 3, when prediction indicates that the possible range of quotients is 4 to 9, “R−5DIVs” (i.e., the intermediate remainder minus the fifth multiple of the divisor) and “R−8DIVs” (i.e., the intermediate remainder minus the eighth multiple of the divisor) are calculated as two subtractions performed by the two subtracters in the first subtraction loop. Carry-out bits obtained as a result may be positive and negative, respectively. Such outcomes indicate that the possible range of quotients is 5 to 7. In response, the partial quotient Q is tentatively set equal to 5, and the intermediate remainder R is set equal to the subtraction result R1 of the first subtracter. In the second subtraction loop, “R−1DIVs” (i.e., the intermediate remainder minus the first multiple of the divisor) and “R−2DIVs” (i.e., the intermediate remainder minus the second multiple of the divisor) are calculated as two subtractions performed by the two subtracters. Carry-out bits obtained as a result may be positive and positive, respectively. Such outcomes indicate that the possible value of the quotient is 7. In response, the partial quotient Q is increased by 2 to become 7 (=5+2), and the intermediate remainder R is set equal to the subtraction result R2 of the second subtracter. In FIG. 3, symbols “−” and “*” indicate that corresponding events are not possible to happen according to the algorithm being used.

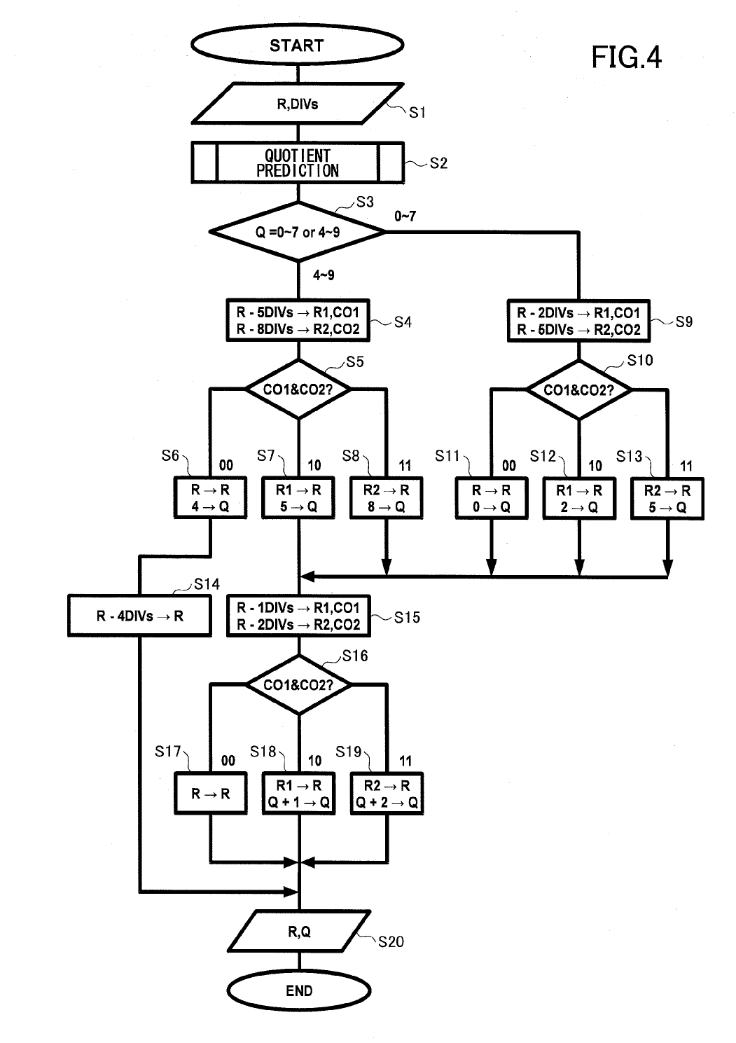

FIG. 4 is a flowchart illustrating a process flow of the algorithm illustrated in FIG. 3. In the following, a description will be given of the process steps of this algorithm.

In step S1, the intermediate remainder R and the divisor DIVs are provided as inputs. In step S2, quotient prediction is made. This quotient prediction is performed by identifying one of the group (including quotients of 0 to 7) on the upper side of the boundary in the table of FIG. 2 and the group (including quotients of 4 to 9) on the lower side of the boundary 10 based on information about the two most significant bits of the dividend (i.e., intermediate remainder) and the most significant bit of the divisor.

In step S3, a select signal is generated such that a process in step S4 is performed when the possible range of quotients is 4 to 9, and such that a process in step S9 is performed when the possible range of quotient is 0 to 7.

In step S4, the intermediate remainder and the divisor are supplied to the first and second subtracters. The first subtracter subtracts the fifth multiple of the divisor from the intermediate remainder R to produce the intermediate remainder R1 and the carry-out bit CO1. The second subtracter subtracts the eighth multiple of the divisor from the intermediate remainder R to produce the intermediate remainder R2 and the carry-out bit CO2.

In step S5, values to be set to the intermediate remainder R and the partial quotient Q are selected in response to a combination of the carry-out bits CO1 and CO2 of the first and second respective subtracters. When CO1 and CO2 are 0 and 0, respectively, in step S6, the value of the intermediate remainder R is left unchanged, and the partial quotient Q is set equal to 4. When CO1 and CO2 are 1 and 0, respectively, in step S7, the intermediate remainder R is set equal to the intermediate remainder R1, and the partial quotient Q is set equal to 5. When CO1 and CO2 are 1 and 1, respectively, in step S8, the intermediate remainder R is set equal to the intermediate remainder R2, and the partial quotient Q is set equal to 8.

In step S9, the intermediate remainder and the divisor are supplied to the first subtracter and the second subtracter. The first subtracter subtracts the second multiple of the divisor from the intermediate remainder R to produce the intermediate remainder R1 and the carry-out bit CO1. The second subtracter subtracts the fifth multiple of the divisor from the intermediate remainder R to produce the intermediate remainder R2 and the carry-out bit CO2.

In step S10, values to be set to the intermediate remainder R and the partial quotient Q are selected in response to a combination of the carry-out bits CO1 and CO2 of the first and second respective subtracters. When CO1 and CO2 are 0 and 0, respectively, in step S11, the value of the intermediate remainder R is left unchanged, and the partial quotient Q is set equal to 0. When CO1 and CO2 are 1 and 0, respectively, in step S12, the intermediate remainder R is set equal to the intermediate remainder R1, and the partial quotient Q is set equal to 2. When CO1 and CO2 are 1 and 1, respectively, in step S13, the intermediate remainder R is set equal to the intermediate remainder R2, and the partial quotient Q is set equal to 5.

The first subtraction loop is performed as described above. Subsequently, the second subtraction loop as will be described below is performed.

When the quotient prediction indicates a range of 4 to 9, and when CO1 and CO2 in the first subtraction loop are 0 and 0, respectively, in step S14, the fourth multiple of the divisor is subtracted from the intermediate remainder R, and the result of the subtraction is used as the intermediate remainder R.

In conditions other than the condition that the quotient prediction indicates a range of 4 to 9 and CO1 and CO2 in the first subtraction loop are 0 and 0, respectively, in step S15, the intermediate remainder and the divisor are applied to the first subtracter and the second subtracter. The first subtracter subtracts the divisor from the intermediate remainder R to produce the intermediate remainder R1 and the carry-out bit CO1. The second subtracter subtracts the second multiple of the divisor from the intermediate remainder R to produce the intermediate remainder R2 and the carry-out bit CO2.

In step S16, values to be set to the intermediate remainder R and the partial quotient Q are selected in response to a combination of the carry-out bits CO1 and CO2 of the first and second respective subtracters. When CO1 and CO2 are 0 and 0, respectively, in step S17, the value of the intermediate remainder R is left unchanged, and the partial quotient Q is also left unchanged. When CO1 and CO2 are 1 and 0, respectively, in step S18, the intermediate remainder R is set equal to the intermediate remainder R1, and the partial quotient Q is increased by 1. When CO1 and CO2 are 1 and 1, respectively, in step S19, the intermediate remainder R is set equal to the intermediate remainder R2, and the partial quotient Q is increased by 2.

In final step S20, the intermediate remainder R and the partial quotient Q are output. With the above-noted procedure, the intermediate remainder R and the partial quotient Q are obtained by performing two subtraction loops.

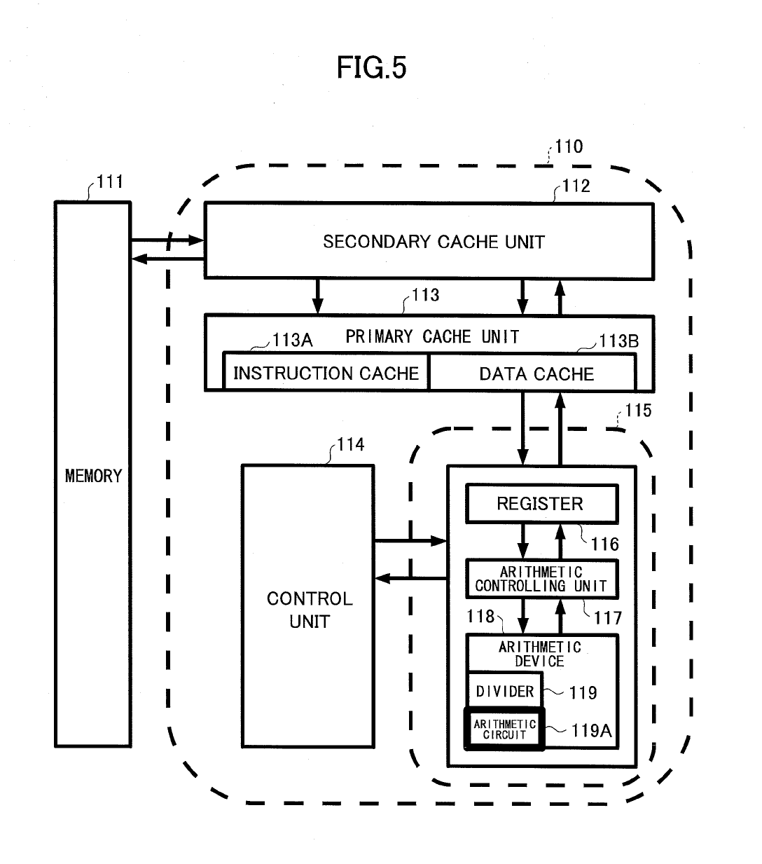

FIG. 5 is a drawing illustrating an example of the configuration of a computer system. The computer system illustrated in FIG. 5 includes a processor 110 and a memory 111. The processor 110 serving as a processor includes a secondary cache unit 112, a primary cache unit 113, a control unit 114, and an arithmetic unit 115. The primary cache unit 113 includes an instruction cache 113A and a data cache 113B. The arithmetic unit 115 includes a register 116, an arithmetic controlling unit 117, and an arithmetic device 118. The arithmetic device 118 includes a divider 119. The divider 119 includes an arithmetic circuit 119A for calculating a partial remainder and a partial quotient. In FIG. 5 and the subsequent drawings, boundaries between functional blocks illustrated as boxes basically indicate functional boundaries, and may not correspond to separation in terms of physical positions, separation in terms of electrical signals, separation in terms of control logic, etc. Each functional block may be a hardware module that is physically separated from other blocks to some extent, or may indicate a function in a hardware module in which this and other blocks are physically combined together. Each functional block may be a module that is logically separated from other blocks to some extent, or may indicate a function in a module in which this and other blocks are logically combined together.

The above-noted computer system is an exemplified information processing apparatus utilizing a CPU (central processing unit), and is used to implement hardware for performing arithmetic on Oracle-numbers. In the processor 110, the cache memory system implemented as having a multilayer structure in which the primary cache unit 113 and the secondary cache unit 112 are provided. Specifically, the secondary cache unit 112 that can be accessed faster than the main memory is situated between the primary cache unit 113 and the main memory (i.e., the memory 111). With this arrangement, the frequency of access to the main memory upon the occurrence of cache misses in the primary cache unit 113 is reduced, thereby lowering cache-miss penalty.

The control unit (instruction control unit) 114 issues an instruction fetch address and an instruction fetch request to a primary instruction cache 113A to fetch an instruction from this instruction fetch address. The control unit 114 controls the arithmetic unit 115 in accordance with the decode results of the fetched instruction (e.g., division instruction) to execute the fetched instruction. The arithmetic controlling unit 117 operates under the control of the control unit 114 to supply data to be processed from the register 116 to the arithmetic device 118 and to store processed data in the register 116 at a specified register location. Further, the arithmetic controlling unit 117 specifies the type of arithmetic performed by the arithmetic device 118. Moreover, the arithmetic controlling unit 117 specifies an address to be accessed to perform a load instruction or a store instruction with respect to this address in the primary cache unit 113. Data read from the specified address by the load instruction is stored in the register 116 at a specified register location. Data stored at a specified location in the register 116 is written to the specified address by the store instruction. The arithmetic circuit 119A of the divider 119 included in the arithmetic device 118 serves to calculate a partial quotient and an intermediate remainder, and may be a circuit that can produce results with two adders by use of two loops based on the coarse quotient prediction that was previously described.

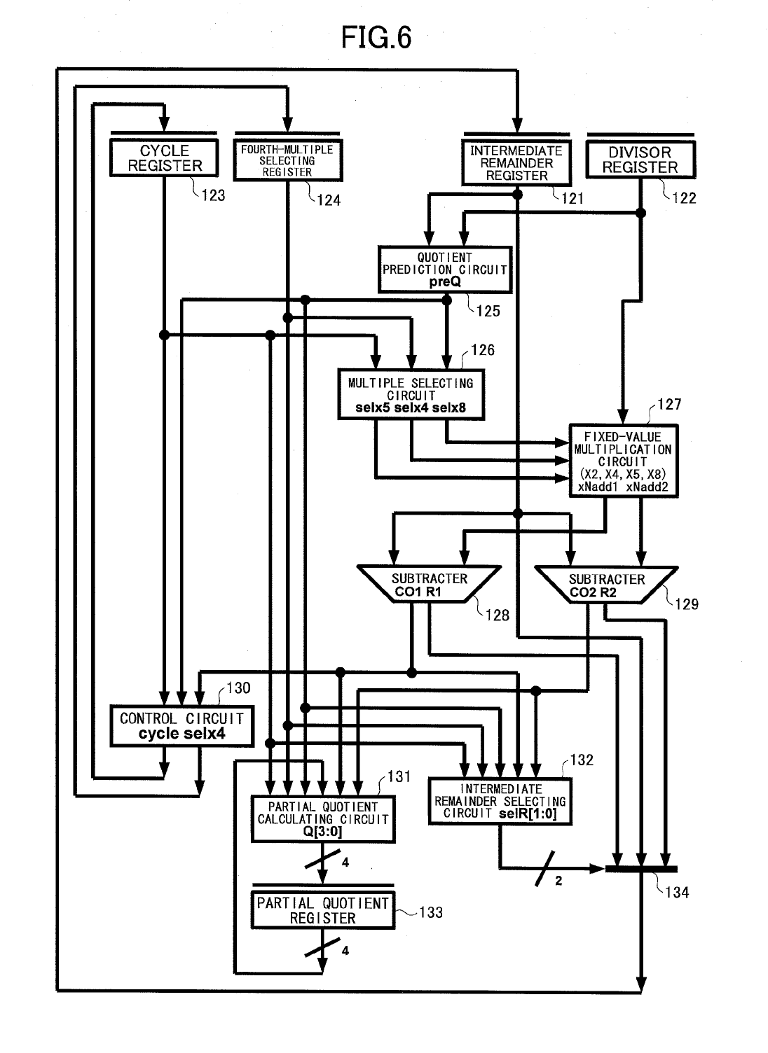

FIG. 6 is a drawing illustrating an example of the configuration of the arithmetic circuit 119A. The arithmetic circuit 119A illustrated in FIG. 6 includes an intermediate remainder register 121, a divisor register 122, a cycle register 123, a fourth-multiple selecting register 124, a quotient prediction circuit 125, a multiple selecting circuit 126, a fixed-value multiplication circuit 127, a subtracter 128, a subtracter 129, and a control circuit 130. The arithmetic circuit 119A further includes a partial quotient calculating circuit 131, an intermediate remainder selecting circuit 132, a partial quotient register 133, and a selector 134.

The fixed-value multiplication circuit 127 generates the second multiple of the divisor, the fourth multiple of the divisor, the fifth multiple of the divisor, and the eighth multiple of the divisor. Among the multiples of a binary coded decimal number, these N-th multiples of a divisor (i.e., N=2, 4, 5, 8) can be generated by use of simpler logic than the logic for generating other multiples.

In the second-multiple circuit, doubling the value of each digit will result in the value of each digit being an even number when carry propagation is ignored. As a result, the carry propagated from the lower digit can be accommodated in the least significant bit of each digit. It follows that there is no need to take into account successive carry propagations. When calculating the value of a digit of interest, only the value of this digit and the value of the next lower digit may be taken into account. Accordingly, a circuit for calculating a second multiple can be implemented as a combinatorial logic circuit based on a truth table that defines input values and output values. A circuit implemented in such a manner can calculate a second multiple faster than an adder calculating a second multiple.

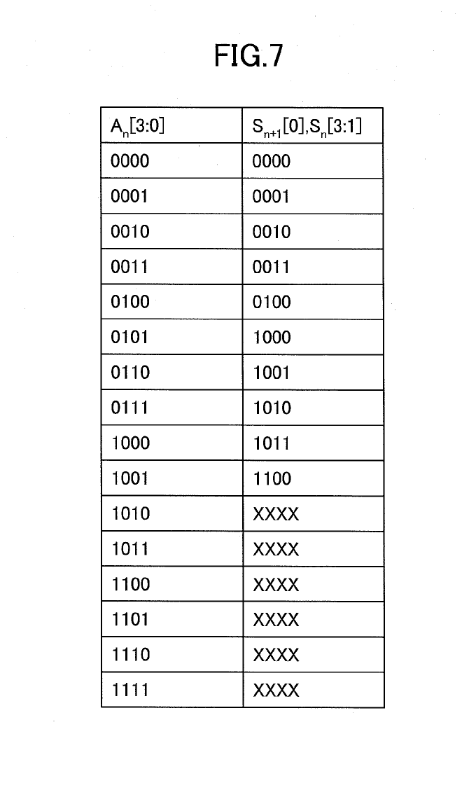

FIG. 7 is a truth table illustrating the input and output of each digit in a second-multiple circuit. Aₙ[3:0] is a 4-bit value that is an input at the n-th digit. Sₙ and Sₙ₊₁ represent a value obtained by doubling Aₙ. Sₙ[3:1] is the three upper bits of the four bits of the n-th digit, and Sₙ₊₁[0] is the least significant bit of the four bits of the n+1-th digit. When Aₙ[3:0] is 1000 (i.e., 8 in decimal notation), for example, double this number (i.e., 16 in decimal notation) has 0001 at the n+1-th digit and 0110 at the n-th digit. As a result, Sₙ₊₁[0]=1 and Sₙ[3:1]=011 are obtained as illustrated in FIG. 7. A combinatorial logic circuit that implements the truth table defining these input and output values may be designed as a second multiple circuit.

In the case of a fourth-multiple circuit and an eighth-multiple circuit, two carry bits may be generated under some circumstances. Because of this, a circuit cannot be designed based on a single-digit truth table as described above. Since the second-multiple circuit can be implemented by a simple combinatorial logic circuit, a fourth-multiple circuit may be implemented by connecting two second-multiple circuits in series, and an eighth-multiple circuit may be implemented by connecting three second-multiple circuits in series.

In the case of a fifth-multiple circuit, an outcome of multiplying an input number by 10 may be divided by 2. This process can be implemented as follows. An input number is shifted to the left by four bits so as to perform 10-fold multiplication. 10 times the input number obtained in this manner is then shifted to the right by one bit so as to perform a halving process. This one-bit right shift operation produces a correct result (i.e., ½ of the input) when every bit “1” moves within the same digit. When a bit “1” moves from the n+1-th digit to the n-th digit, the value generated by the bit “1” moving from the n+1-th digit to the n-th digit is equal to 8 (1000₂). Half of the bit “1” in the n+1-th digit is equal to 5 in the n-th digit, so that the value “8” generated by the bit “1” moving from the n+1-th digit to the n-th digit is desirably converted into 5. In consideration of the above, when the most significant digit is 1 in any given digit, the most significant digit is changed to “0”, and 5 is added to this digit. When a one-bit right shift operation is performed as a halving process, the three lower bits of each digit can only assume a value in a range of 0 to 4. Adding 5 as described above does not end up generating a carry-out bit. Accordingly, a circuit for calculating a fifth multiple can be implemented as a combinatorial logic circuit based on a truth table that defines input values and output values. A circuit implemented in such a manner can calculate a fifth multiple faster than an adder calculating a fifth multiple.

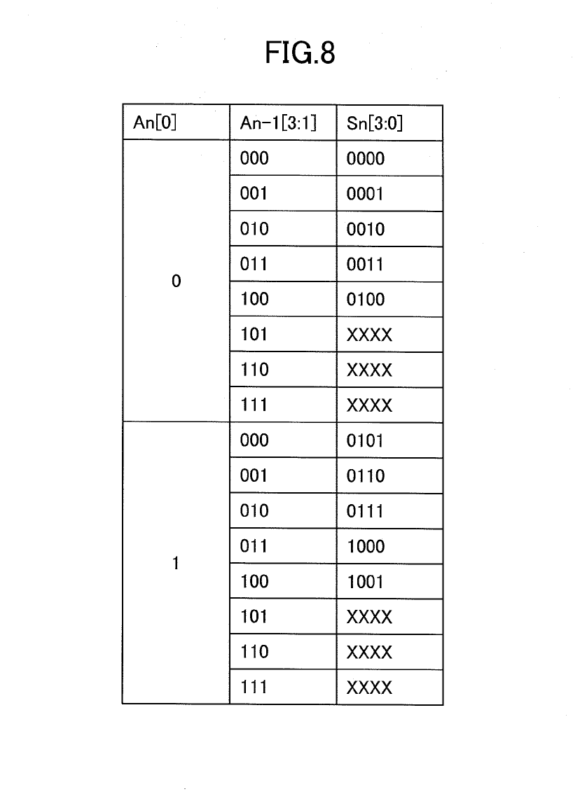

FIG. 8 is a truth table illustrating the input and output of each digit in a fifth-multiple circuit. Aₙ[0] is the least significant bit of the four input bits of the n-th digit, and Aₙ₋₁[3:1] are the three upper bits of the four input bits of the n−1-th digit. This input is shifted to the left by 3 bits (=left shift by 4 bits and right shift by 1 bit). When the most significant bit is 1, the most significant bit is set equal to 0, and 5 is added. The four output bits obtained in this manner for the n-th digit is Sₙ[3:0]. A combinatorial logic circuit that implements the truth table defining these input and output values may be designed as a fifth multiple circuit.

Referring to FIG. 6 again, the second-multiple circuit and the fifth-multiple circuit implemented as described above are embedded in the fixed-value multiplication circuit 127. With this arrangement, the fixed-value multiplication process of the fixed-value multiplication circuit 127 can be performed at high speed. Further, the configuration illustrated in FIG. 6 is not only purposefully designed for the fixed-number multiplication process described above but also purposefully designed for allocation of N-th multiples of a divisor to respective subtracters. In restoring division, selecting an N-th multiple of a divisor is controlled based on the carry-out bits of the subtracters. The magnitude relationships between the N-th multiples of a divisor simultaneously applied to the respective subtracters are thus kept constant for the purpose of simplifying the control of selecting an N-th multiple. The previously-noted algorithm was described in such a manner. In the arithmetic circuit illustrated in FIG. 6, however, such relationships are broken, and the fifth multiple of a divisor is always applied to the first subtracter 128 at the time of first subtraction. This is because the use of the first subtracter 128 always for the fifth multiple of a divisor, when such a multiple is used, can reduce the number of selector stages used in the circuit.

In the following, the operation of the arithmetic circuit illustrated in FIG. 6 will be described. In the following description, FIG. 6 and the subsequent figures, an intermediate remainder R, a divisor DIVs, an N-th multiple of a divisor NDIVs, a partial quotient Q[3:0], a subtraction count check signal “cycle”, a quotient prediction signal preQ, and N-th multiples of a divisor ×Nadd1 and ×Nadd2 supplied to the first and second subtractors, respectively, are used as symbols for notation. Further, a fourth-multiple selecting signal sel×4, a fifth-multiple selecting signal sel×5, an eighth-multiple selecting signal sel×8, carry-out bits CO1 and CO2, partial quotients Q1 and Q2, two most significant bits of an intermediate remainder R[7:0], and the most significant bit of a divisor S[3:0] are used as symbols for notation. The subtraction count check signal “cycle” is during the first subtraction loop and 1 during the second subtraction loop.

In FIG. 6, the intermediate remainder R and the divisor DIVs are supplied to the intermediate remainder register 121 and the divisor register 122, respectively. Further, the subtraction count check signal “cycle” and the fourth-multiple selecting signal sel×4 are supplied to the cycle register 123 and the fourth-multiple selecting register 124, respectively. The intermediate remainder R and the divisor DIVs are supplied to the quotient prediction circuit 125 from the intermediate remainder register 121 and the divisor register 122, respectively.

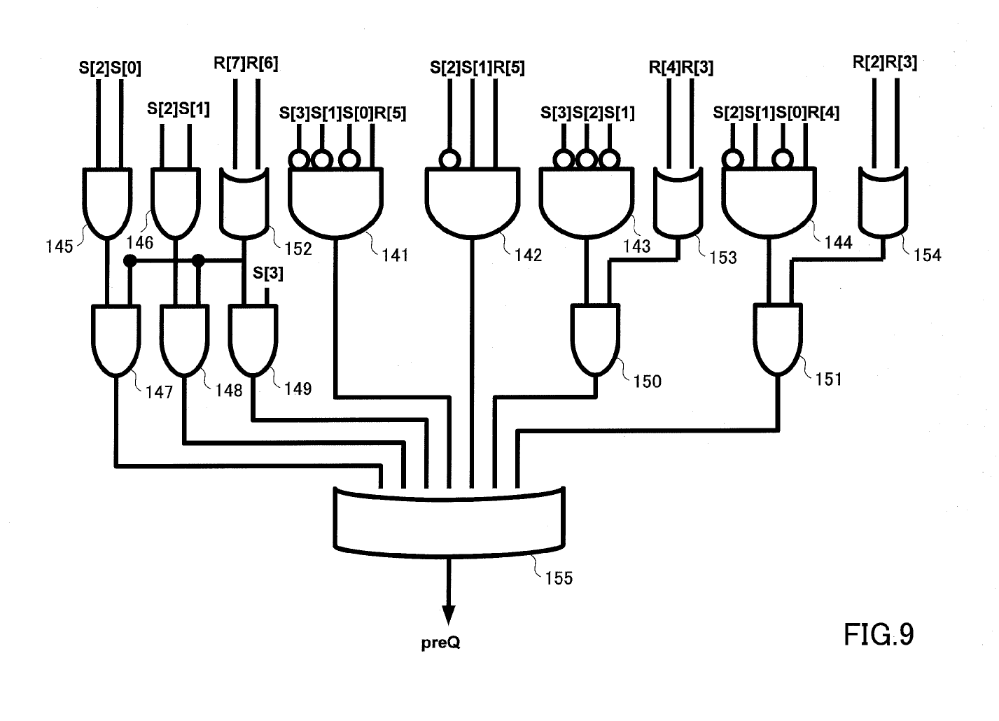

FIG. 9 is a drawing illustrating an example of the configuration of the quotient prediction circuit 125. The quotient prediction circuit 125 illustrated in FIG. 9 includes AND gates 141 through 151 and OR gates 152 through 155. Some of the inputs of the AND gates 141 through 144 are provided according to negative logic. The quotient prediction circuit 125 performs, based on information about the two most significant digits of the intermediate remainder R[7:0] and the most significant digit of the divisor S[3:0], quotient prediction having lower precision than the highest precision obtainable from such information. Namely, the quotient prediction circuit 125 performs quotient prediction based on this information to identify either one of the group (including quotients of 0 to 7) on the upper side of the boundary 10 in the table of FIG. 2 and the group (including quotients of 4 to 9) on the lower side of the boundary 10. It may be noted that, in FIG. 9, not all the bits of the two most significant digits R[7:0] of the intermediate remainder are used (for example, R[0] is not used). Namely, quotient prediction is performed by use of part but not all of the bits comprised of the two most significant digits R[7:0] of the intermediate remainder and the most significant digit S[3:0] of the divisor. The quotient prediction circuit 125 generates a select signal that assumes 1 in the case of the possible quotient range being 4 to 9 and assumes 0 in the case of the possible quotient range being 0 to 7. The quotient prediction circuit 125 supplies the generated select signal to the multiple selecting circuit 126, the control circuit 130, and the partial quotient calculating circuit 131.

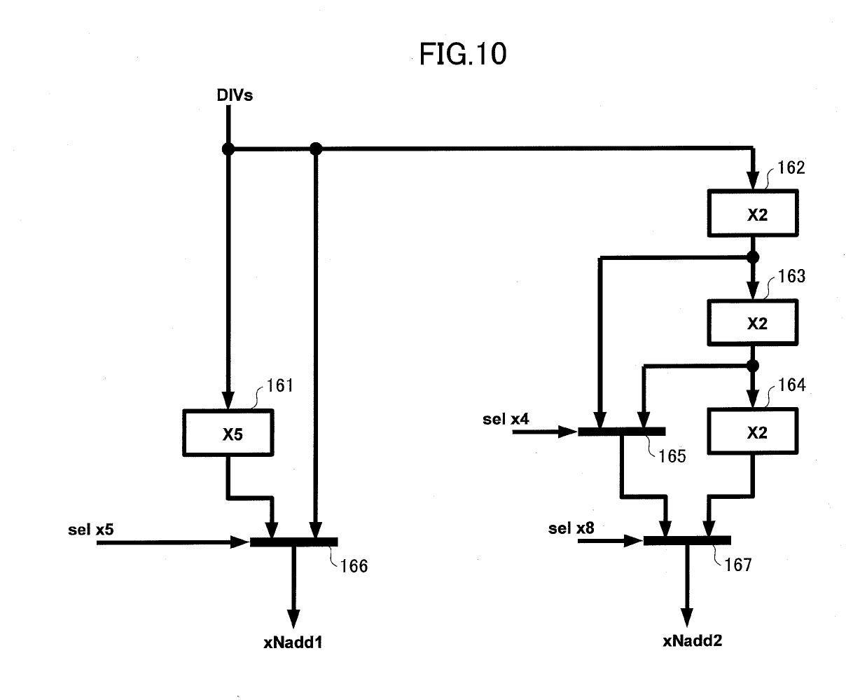

FIG. 10 is a drawing illustrating an example of the configuration of the fixed-value multiplication circuit 127. The fixed-value multiplication circuit 127 illustrated in FIG. 10 includes a fifth-multiple circuit 161, second-multiple circuits 162 through 164, and selectors 165 through 167. The N-th multiple ×Nadd1 of a divisor selected and output by the selector 166 is supplied to the subtracter 128. The N-th multiple ×Nadd2 of a divisor selected and output by the selector 167 is supplied to the subtracter 129. The fourth-multiple selecting signal sel×4, the fifth-multiple selecting signal sel×5, and the eighth-multiple selecting signal sel×8 are supplied from the multiple selecting circuit 126.

The fixed-value multiplication circuit 127 supplies the fifth multiple of a divisor to the subtracter 128 in the case of the fifth-multiple selecting signal sel×5 being 1, and supplies an original divisor (the first multiple of a divisor) to the subtracter 128 in the case of the fifth-multiple selecting signal sel×5 being 0. The fixed-value multiplication circuit 127 supplies the second multiple of a divisor to the subtracter 129 when the fourth-multiple selecting signal sel×4 and the eighth-multiple selecting signal sel×8 are 0 and 0, respectively. The fixed-value multiplication circuit 127 supplies the fourth multiple of a divisor to the subtracter 129 when the fourth-multiple selecting signal sel×4 and the eighth-multiple selecting signal sel×8 are 1 and 0, respectively. The fixed-value multiplication circuit 127 supplies the eighth multiple of a divisor to the subtracter 129 when the eighth-multiple selecting signal sel×8 is 1.

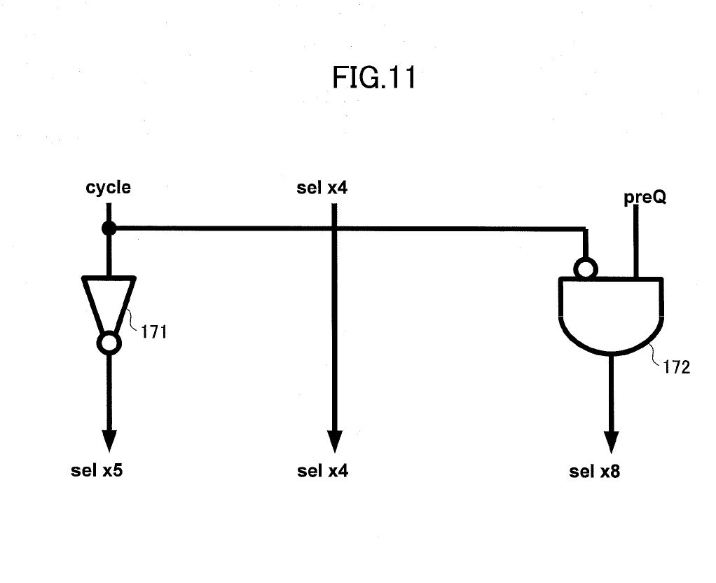

FIG. 11 is a drawing illustrating an example of the configuration of the multiple selecting circuit 126. The multiple selecting circuit 126 includes an inverter 171 and an AND gate 172. One of the two inputs of the AND gate 172 is provided as negative logic. The multiple selecting circuit 126 receives as its inputs the subtraction count check signal “cycle” from the cycle register 123, the fourth-multiple selecting signal sel×4 from the fourth-multiple selecting register 124, and the quotient prediction signal preQ from the quotient prediction circuit 125. In response to these inputs, the multiple selecting circuit 126 sets the fourth-multiple selecting signal sel×4, the fifth-multiple selecting signal sel×5, and the eighth-multiple selecting signal sel×8 equal to either 0 or 1, separately.

The multiple selecting circuit 126 sets the fifth-multiple selecting signal sel×5 equal to 1 in the case of the subtraction count check signal “cycle” being 0. The multiple selecting circuit 126 outputs the supplied fourth-multiple selecting signal sel×4 without any change. The multiple selecting circuit 126 sets the eighth-multiple selecting signal sel×8 equal to 1 when the subtraction count check signal “cycle” and the quotient prediction signal preQ are 0 and 1, respectively.

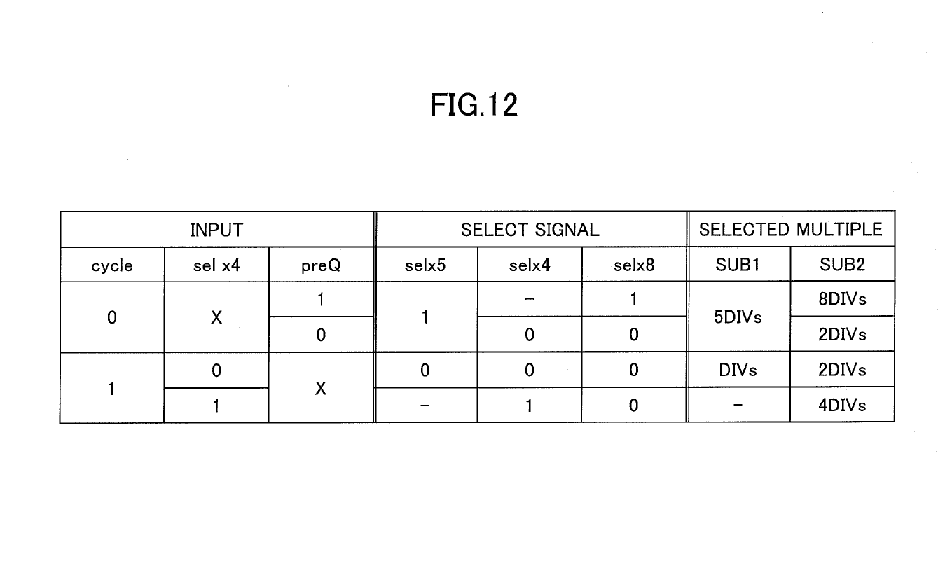

FIG. 12 is a table illustrating relationships between inputs and outputs of the multiple selecting circuit 126 and the fixed-value multiplication circuit 127. The fixed-value multiplication circuit 127 illustrated in FIG. 10 and the multiple selecting circuit 126 illustrated in FIG. 11 operate as defined in the table of FIG. 12. When the subtraction count check signal “cycle”, the fourth-multiple selecting signal sel×4, and the quotient prediction signal preQ are 0, 0, and 0, respectively, for example, the fifth-multiple selecting signal sel×5, the fourth-multiple selecting signal sel×4, and the eighth-multiple selecting signal sel×8 are set equal to 1, 0, 0, respectively. At this time, the N-th multiple of a divisor supplied to the first subtracter 128 (SUB1) is the fifth multiple of a divisor, and the N-th multiple of a divisor supplied to the second subtracter 129 (SUB2) is the second multiple of a divisor.

Referring to FIG. 6 again, the subtracter 128 subtracts the supplied N-th multiple of a divisor from the supplied intermediate remainder R to produce the intermediate remainder R1 as a subtraction result and the carry-out bit CO1 of the subtraction. The subtracter 129 subtracts the supplied N-th multiple of a divisor from the supplied intermediate remainder R to produce the intermediate remainder R2 as a subtraction result and the carry-out bit CO2 of the subtraction. The carry-out bit CO1 is supplied to the partial quotient calculating circuit 131. The partial quotient calculating circuit 131 receives the carry-out bits CO1 and CO2. Also, the intermediate remainder selecting circuit 132 receives the carry-out bits CO1 and CO2.

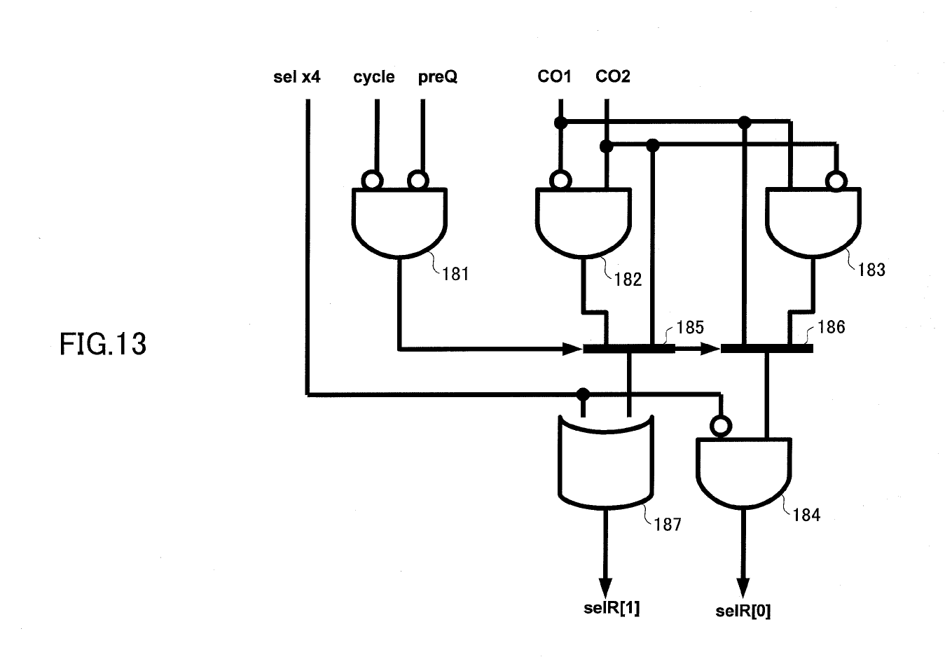

FIG. 13 is a drawing illustrating an example of the configuration of the intermediate remainder selecting circuit 132. The intermediate remainder selecting circuit 132 illustrated in FIG. 13 includes AND gates 181 through 184 some inputs of which are provided as negative logic, selectors 185 and 186, and an OR gate 187. The intermediate remainder selecting circuit 132 receives as its inputs the subtraction count check signal “cycle”, the fourth-multiple selecting signal sel×4, the quotient prediction signal preQ, and the carry-out bits CO1 and CO2.

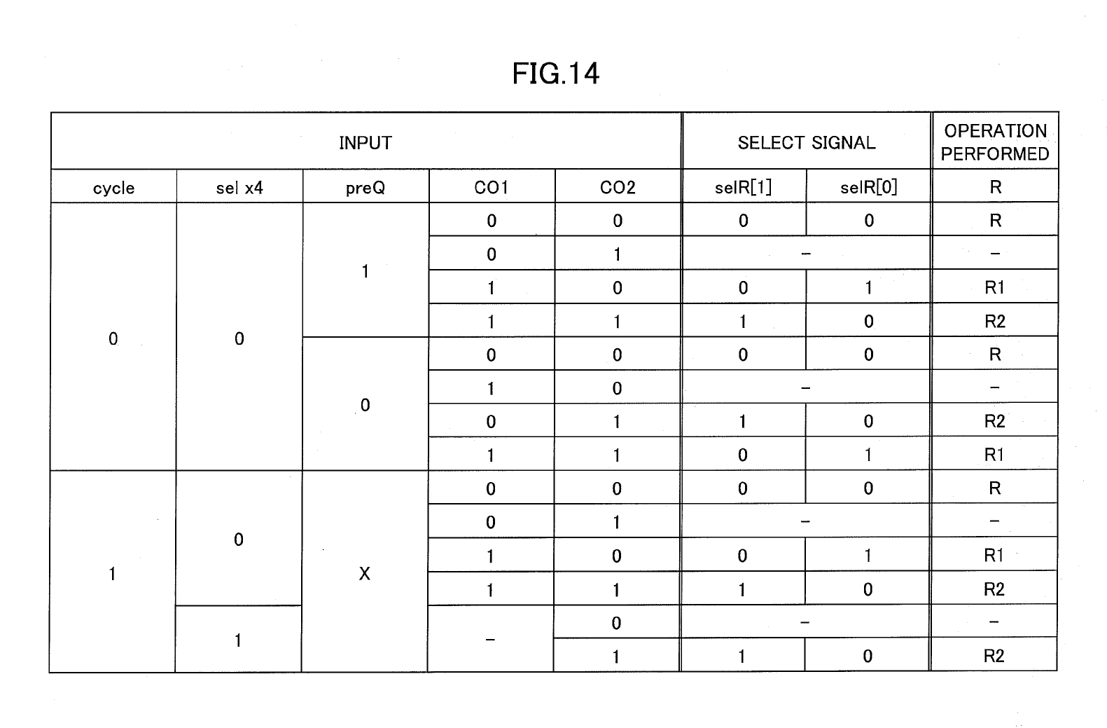

FIG. 14 is a drawing illustrating relationships between inputs and outputs of the intermediate remainder selecting circuit 132. Upon receiving inputs, the intermediate remainder selecting circuit 132 outputs select signals selR[1] and selR[0] as illustrated in the table of FIG. 14. The select signals selR[1] and selR[0] are supplied to the selector 134 as illustrated in FIG. 6.

In FIG. 6, the selector 134 selects the intermediate remainder R of the intermediate remainder register 121, the intermediate remainder R1 supplied as the subtraction result of the subtracter 128, or the intermediate remainder R2 supplied as the subtraction result of the subtracter 129 in response to the select signals selR[1] and selR[0]. The selected intermediate remainder is supplied to and stored in the intermediate remainder register 121. Specifically, when the select signals selR[1] and selR[0] are 0 and 0, respectively, the intermediate remainder R is selected. When the select signals selR[1] and selR[0] are 0 and 1, respectively, the intermediate remainder R1 is selected. When the select signals selR[1] and selR[0] are 1 and 0, respectively, the intermediate remainder R2 is selected.

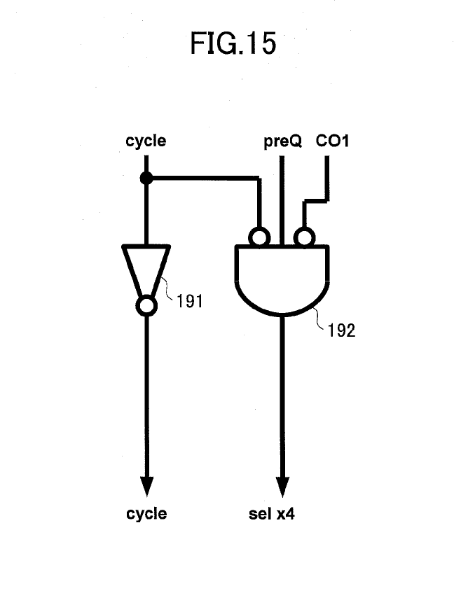

FIG. 15 is a drawing illustrating an example of the configuration of the control circuit 130. The control circuit 130 illustrated in FIG. 15 includes an inverter 191 and an AND gate 192 some inputs of which are provided as negative logic. The control circuit 130 receives as its inputs the subtraction count check signal “cycle”, the quotient prediction signal preQ, and the carry-out bit CO1. The control circuit 130 inverts the subtraction count check signal “cycle”. The inverted subtraction count check signal “cycle” is supplied to and stored in the cycle register 123. Only when the subtraction count check signal “cycle”, the quotient prediction preQ, and the carry-out bit CO1 are 0, 1, 0, respectively, the control circuit 130 sets the fourth-multiple selecting signal sel×4 equal to 1. The fourth-multiple selecting signal sel×4 set equal to 1 is supplied to and stored in the fourth-multiple selecting register 124.

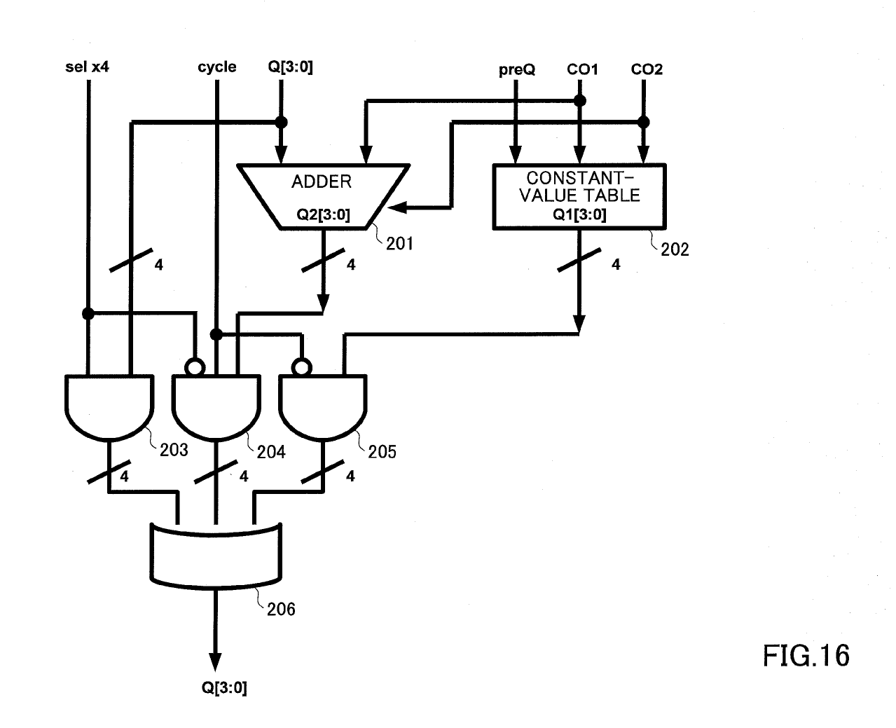

FIG. 16 is a drawing illustrating an example of the configuration of the partial quotient calculating circuit 131. The partial quotient calculating circuit 131 illustrated in FIG. 16 includes an adder 201, a constant-value table 202, AND gates 203 through 205, and an OR gate 206. One of the two inputs of the AND gates 204 and 205 is provided as negative logic. The partial quotient calculating circuit 131 receives as its inputs the subtraction count check signal “cycle”, the fourth-multiple selecting signal sel×4, the quotient prediction signal preQ, the carry-out bits CO1 and CO2, and the partial quotient Q from the partial quotient register 133.

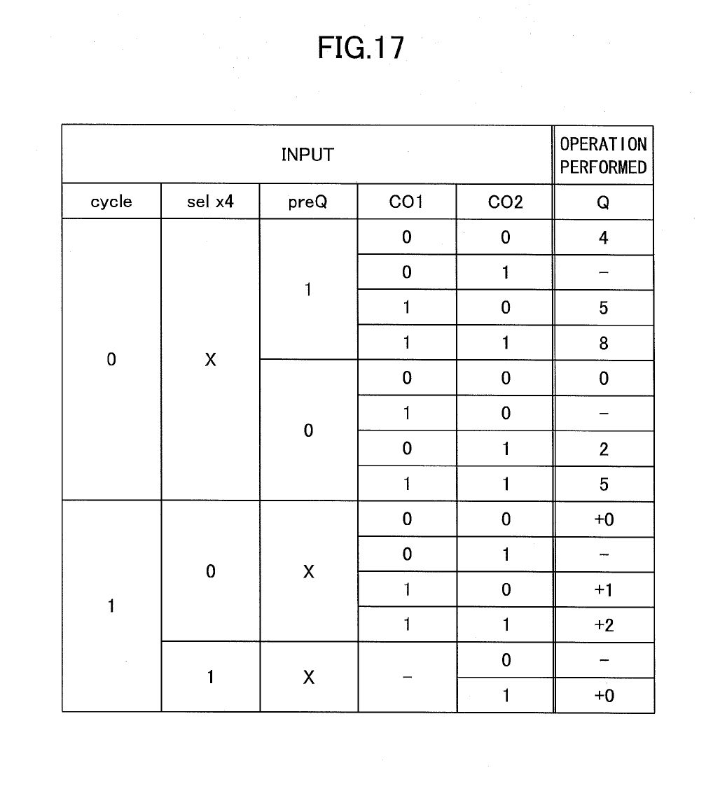

FIG. 17 is a drawing illustrating relationships between inputs and outputs of the partial quotient calculating circuit 131. Upon receiving inputs, the partial quotient calculating circuit 131 outputs a partial quotient as illustrated in the table of FIG. 17. In FIG. 17, a numerical value such as 4, 5, or the like shown as Q of the “performed process” indicates that the indicated value is produced as the partial quotient Q. Further, an arithmetic operation such as +1, +2, or the like shown as Q of the “performed process” indicates that the indicated arithmetic operation is performed on the current partial quotient Q.

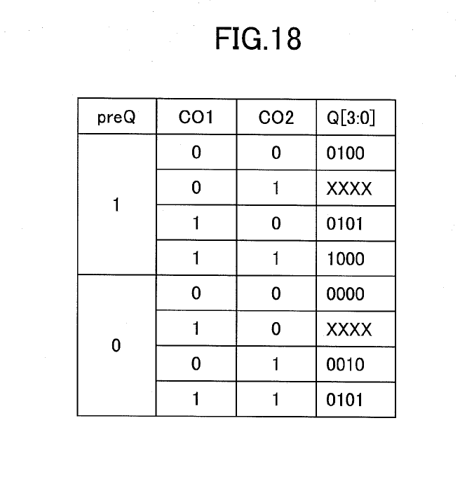

FIG. 18 is a table illustrating relationships between inputs and outputs of the constant-value table 202 of FIG. 16. The quotient prediction signal preQ, the carry-out bit CO1, and the carry-out bit CO2 are used to select one of the plurality of constant values stored in the constant-value table 202, and the selected constant value is output from the table. When the quotient prediction signal preQ, the carry-out bit CO1, and the carry-out bit CO2 are 1, 1, 0, respectively, a partial quotient Q having a value of 0101 is output. In the following, the output of the constant-value table 202 will be referred to as a first partial quotient.

Referring to FIG. 16 again, the partial quotient Q from the partial quotient register 133 and the carry-out bit CO1 are supplied to the adder 201 as its inputs, and the carry-out bit CO2 is supplied to the adder 201 as an input carry bit. The result of addition by the adder 201 will be referred to as a second partial quotient in the following.

When the fourth-multiple selecting signal sel×4 is 1, the partial quotient Q is output from the partial quotient calculating circuit 131 through the OR gate 206. The output partial quotient Q is supplied to and stored in the partial quotient register 133. When the subtraction count check signal “cycle” is 0, the first partial quotient as defined above is output from the partial quotient calculating circuit 131 through the OR gate 206. The output partial quotient Q is supplied to and stored in the partial quotient register 133. When the fourth-multiple selecting signal sel×4 and the subtraction count check signal “cycle” are 0 and 1, respectively, the second partial quotient as defined above is output from the partial quotient calculating circuit 131 through the OR gate 206. The output partial quotient Q is supplied to and stored in the partial quotient register 133.

The arithmetic circuit 119A illustrated in FIG. 6 operates as described above to perform the algorithm illustrated in FIG. 4, thereby obtaining an intermediate remainder and a partial quotient in two arithmetic operation loops. The arithmetic circuit 119A illustrated in FIG. 6 uses the quotient prediction circuit 125 having a simple configuration to perform coarse quotient prediction, so that the number of arithmetic operation loops can be reduced (e.g., reduced to two in the example illustrated in FIG. 6). Further, the processes in the arithmetic operation loops are implemented by use of simple circuits, which allows the use of high operating frequency in an implemented circuit. An arithmetic circuit that has a small circuit size and operates at high speed is thus provided.

According to at least one embodiment, an arithmetic circuit is provided that utilizes an efficient circuit configuration to reduce the number of subtraction loops in restoring division.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An arithmetic circuit for performing division based on restoring division, comprising:
an intermediate remainder register configured to store an intermediate remainder;
a quotient prediction circuit configured to perform, based on information about two most significant digits of the intermediate remainder and a most significant digit of a divisor, quotient prediction having lower precision than a highest precision obtainable from the information, thereby generating a prediction result;
a fixed-value multiplication circuit configured to output one or more N-th (N: integer) multiples of the divisor selected in response to the prediction result generated by the quotient prediction circuit;
one or more subtracters configured to subtract, from the intermediate remainder, the one or more N-th multiples of the divisor output from the fixed-value multiplication circuit; and
a partial quotient calculating circuit configured to obtain a partial quotient in response to one or more carry-out bits of one or more subtractions performed by the one or more subtracters.

2. The arithmetic circuit as claimed in claim 1, wherein the prediction result generated by the quotient prediction circuit based on the information is a signal indicative of a group that is a sub-set of a set that contains all possible values of the partial quotient, the signal identifying one group among a plurality of groups that have one or more overlaps.

3. The arithmetic circuit as claimed in claim 1, wherein a number of the groups that have one or more overlaps is two.

4. The arithmetic circuit as claimed in claim 1, wherein the quotient prediction circuit is a combinatorial logic circuit.

5. The arithmetic circuit as claimed in claim 1, wherein the fixed-value multiplication circuit outputs a plurality of N-th multiples of the divisor selected in response to the prediction result, and the one or more subtracters include a plurality of subtracters that receive the plurality of N-th multiples of the divisor, respectively.

6. A processor, comprising:
an arithmetic circuit configured to perform division based on restoring division; and
an instruction control unit configured to decode an instruction for the division,
wherein the arithmetic circuit includes:
an intermediate remainder register configured to store an intermediate remainder;
a quotient prediction circuit configured to perform, based on information about two most significant digits of the intermediate remainder and a most significant digit of a divisor, quotient prediction having lower precision than a highest precision obtainable from the information, thereby generating a prediction result;
a fixed-value multiplication circuit configured to output one or more N-th (N: integer) multiples of the divisor selected in response to the prediction result generated by the quotient prediction circuit;
one or more subtracters configured to subtract, from the intermediate remainder, the one or more N-th multiples of the divisor output from the fixed-value multiplication circuit; and
a partial quotient calculating circuit configured to obtain a partial quotient in response to one or more carry-out bits of one or more subtractions performed by the one or more subtracters.

7. A division method in an arithmetic circuit for performing division based on restoring division, comprising:
performing, based on information about two most significant digits of an intermediate remainder and a most significant digit of a divisor, quotient prediction having lower precision than a highest precision obtainable from the information, thereby generating a prediction result;
subtracting, from the intermediate remainder, one or more N-th (N: integer) multiples of the divisor selected in response to the prediction result; and
obtaining a partial quotient in response to one or more carry-out bits obtained from the subtracting.
